(19) United States
(12) Patent Application Publication
(10) Pub. No.: US 2022/0037795 A1
(43) Pub. Date: Feb. 3, 2022

(54) SCALABLE HIGH COMPACTION RATIO HOOP COLUMN DEPLOYABLE MESH REFLECTOR SYSTEM

(71) Applicant: Eagle Technology, LLC, Melbourne, FL (US)

(72) Inventors: Robert M. Taylor, Rockledge, FL (US); Dana M. Rosennier, Melbourne, FL (US)

(73) Assignee: Eagle Technology, LLC

(21) Appl. No.: 16/943,580

(22) Filed: Jul. 30, 2020

(51) Int. Cl. H01Q 15/16

(52) U.S. Cl. CPC H01Q 15/161

(57) ABSTRACT

Systems and methods for operating a reflector system. The methods comprise: structurally supporting a mesh reflector surface using a circumferential hoop that is coupled to a boom via cords; supporting the circumferential hoop using a series of cords extending at least from a base structure of the reflector system to the circumferential hoop and from the boom to the circumferential hoop (where the line of action of all the cords intersect an axis of symmetry of the circumferential hoop); and preventing rotation of the circumferential hoop using at least a first set of additional cords extending from the base structure of the reflector system to the circumferential hoop (where the additional cords of the first set both point to a first point that is horizontally offset from the axis of symmetry).

### BACKGROUND

### Statement of Technical Field

The present document relate to compact antenna system structures. More particularly, the present document relates to a compact deployable antenna reflector structure.

### Description of Related Art

Various conventional antenna structures exist that include a reflector for directing energy into a desired pattern. One such conventional antenna structure is a radial rib reflector design comprising a plurality of reflector ribs joined together at a common cylindrical shaped hub. The reflector ribs provide structural support to a flexible antenna reflector surface attached thereto. A plurality of cords, wires, guidelines, or other tensile members couple the flexible antenna reflector surface to the reflector ribs. The wires or guidelines define and maintain the shape of the flexible antenna reflector surface. The radial rib reflector is collapsible so that it can be transitioned from a deployed position to a stowed position. In the deployed position, the radial rib reflector has a generally parabolic shape. In the stowed position, the reflector ribs are folded up against each other. As a result, the antenna reflector has a stowed height approximately equal to the reflector's radius.

Another conventional antenna structure is a folding rib reflector having a similar design to the radial rib reflector design described above. However, the reflector ribs include a first rib shaft and second rib shaft joined together by a common joint. In the stowed position, the first rib shafts are folded up against the second rib shafts. As such, the antenna reflector has a stowed height that is less than the stowed height of the radial rib reflector design. However, the stowed diameter of the folding rib reflector is larger than the stowed diameter of the radial rib reflector design.

In each of the previous designs, the aperture of the reflector is directly related to the length of the ribs, such that any increase in aperture size requires a directly corresponding increase in rib size and thereby an increased package volume.

Another type of configuration is a hoop reflector where the reflector surface is attached to a circular hoop. To shape the reflector into a parabolic surface, the hoop must have thickness out of the plane of the hoop that is greater than the depth of the parabolic surface. The hoop also must have bending stiffness to prevent the attachments to the reflector from warping out of a plane.

### SUMMARY

This document concerns systems and methods for operating a reflector system. The methods comprise: structurally supporting a mesh reflector surface using a circumferential hoop coupled to a boom via cords; supporting the circumferential hoop using a series of cords extending at least from a base structure of the reflector system to the circumferential hoop and from the boom to the circumferential hoop (where the line of action of all the cords intersect an axis of symmetry of the circumferential hoop); and preventing rotation of the circumferential hoop using at least a first set of additional cords extending from the base structure of the reflector system to the circumferential hoop (where the additional cords of the first set point to a first point that is horizontally offset from the axis of symmetry).

In some scenarios, the additional cords of the first set reside in multiple planes that intersect the axis of symmetry at only a point. Alternatively, the additional cords of the first set may each reside in a plane that does not intersect the axis of symmetry.

In those or other scenarios, the first set of additional cords comprises a first cord that opposes positive twisting of the circumferential hoop in a first direction with tension, and a second cord that opposes negative twisting of the circumferential hoop in a second opposed direction with tension. The rotation of the circumferential hoop may be further prevented using a second set of additional cords extending from the base structure of the reflector system to the circumferential hoop. The additional cords of the second set point to a second point that is horizontally offset from the axis of symmetry and/or that is different than the first point to which the additional cords of the first set point.

In those or other scenarios, the additional cords of the first set are coupled to one or more extendable parts of the base structure.

The present document also relates to a reflector system. The reflector system comprises: a boom; a circumferential hoop coupled to the boom via a plurality of cords and having an axis of symmetry; a mesh reflector surface structurally supported by the circumferential hoop; a series of cords structurally supporting the circumferential hoop from the boom (where the cords are coupled to the circumferential hoop and each oriented such that their line of action intersects the axis of symmetry); and at least a first set of additional cords preventing rotation of the circumferential hoop (where the additional cords are coupled to the circumferential hoop and point to a first point that is horizontally offset from the axis of symmetry).

In some scenarios, the additional cords of the first set reside in multiple planes that intersect the axis of symmetry at only a point. Alternatively, the additional cords of the first set may each resides in a plane that does not intersect the axis of symmetry.

In those or other scenarios, the first set of additional cords comprises a first cord that opposes positive twisting of the circumferential hoop in a first direction with tension, and a second cord that opposes negative twisting of the circumferential hoop in a second opposed direction with tension. The rotation of the circumferential hoop may be further prevented using a second set of additional cords extending from the boom to the circumferential hoop. The additional cords of the second set both point to a second point that is horizontally offset from the axis of symmetry. The second point may be different than the first point to which the additional cords of the first set point. Each of the first and second sets of additional cords may comprise a first cord that opposes positive twisting of the circumferential hoop in a first direction with tension, and a second cord that opposes negative twisting of the circumferential hoop in a second opposed direction with tension.

In those or other scenarios, the additional cords of the first set are: coupled to a base structure of the reflector system at a first end to which the series of cords are also attached; are coupled to a base structure of the reflector system at an intermediate location along a length of the base structure that resides between a first end and second end of the base structure, and that is horizontally offset from the axis of symmetry; coupled to a base structure of the reflector system at a first end which is opposed to a second end of the base structure to which the series of cords are coupled; or coupled to one or more extendable parts of a base structure. The additional cords may be formed of a same or different material than the material used to for the series of cords.

### BRIEF DESCRIPTION OF THE DRAWINGS

This disclosure is facilitated by reference to the following drawing figures, in which like numerals represent like items throughout the figures.

FIG. 1 provides an isometric view of a deployable mesh reflector system.

FIGS. 2 and 3 provide isometric views of illustrated deployable mesh reflector systems illustrating differently sized systems in their respective stowed and deployed configurations.

FIG. 4 provides a side elevation view of an illustrative deployable mesh reflector stowed within a housing of the system.

FIG. 5 provides an isometric view of an illustrative hoop assembly in a stowed configuration.

FIG. 6 provides a top plan view of the hoop assembly of FIG. 5.

FIG. 7 provides a front isometric view of an illustrative hinge assembly of the hoop assembly of FIG. 5.

FIG. 8 provides a rear isometric view of the hinge assembly of FIG. 7.

FIG. 9 provides an isometric view of an illustrative gear link member of the hoop assembly of FIG. 5.

FIG. 10 provides a cross-sectional view of a hinge assembly illustrating the gear link members in a stowed configuration.

FIG. 11 provides a cross-sectional view similar to FIG. 10 illustrating the gear link members in a deployed configuration.

FIG. 12 provides an isometric view of a pair of hinge assemblies interconnected by sync rods in a partially deployed configuration.

FIG. 13 provides an isometric view of an exemplary mast assembly in a deployed configuration.

FIG. 14 provides a top plan view of the mast assembly of FIG. 13.

FIGS. 15 and 16 provide front and side elevation views of the mast assembly of FIG. 13 in a stowed configuration.

FIG. 17 provides an expanded isometric view of the antenna feed assembly atop the mast assembly.

FIGS. 18-24 provide isometric views illustrating an illustrative deployment sequence of a deployable mesh reflector system.

FIG. 25A provides a side elevation view of a hoop assembly positioned with respect to a slide assembly, with partial expanded views shown in FIGS. 25B and 25C as indicated.

FIG. 26 provides a top elevation view of the hoop assembly and slide assembly of FIG. 25A.

FIG. 27 provides a side elevation view illustrating actuation of the slide assembly.

FIG. 28 provides a top plan view of an illustrative mesh reflector system incorporating the slide mechanism of FIGS. 25A-27.

FIGS. 29-33 provide isometric views illustrating another illustrative deployment sequence of a deployable mesh reflector system.

FIG. 34 provides an illustration of an illustrative deployable mesh reflector system having certain additional structural elements to prevent distortion of the reflector surface during a torsional mode.

FIG. 35 provides an illustration that is useful for understanding that certain cords of the reflector system shown in FIG. 34 each entirely reside in a single given plane defined by a radial slice of the reflector system that intersects an axis of symmetry.

FIG. 36 provides an illustration that is useful for understanding that additional cords of the reflector system shown in FIG. 34 each (i) reside in multiple planes are inclined to the axis of symmetry and/or (ii) reside in a plane that does not intersect the axis of symmetry.

FIG. 37 provides an illustration showing an illustrative reflector system comprising a plurality of sets of additional cords.

FIGS. 38-40 each provide an illustration showing another illustrative reflector system.

FIG. 41 provides a flow diagram of an illustrative method for operating a reflector system.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

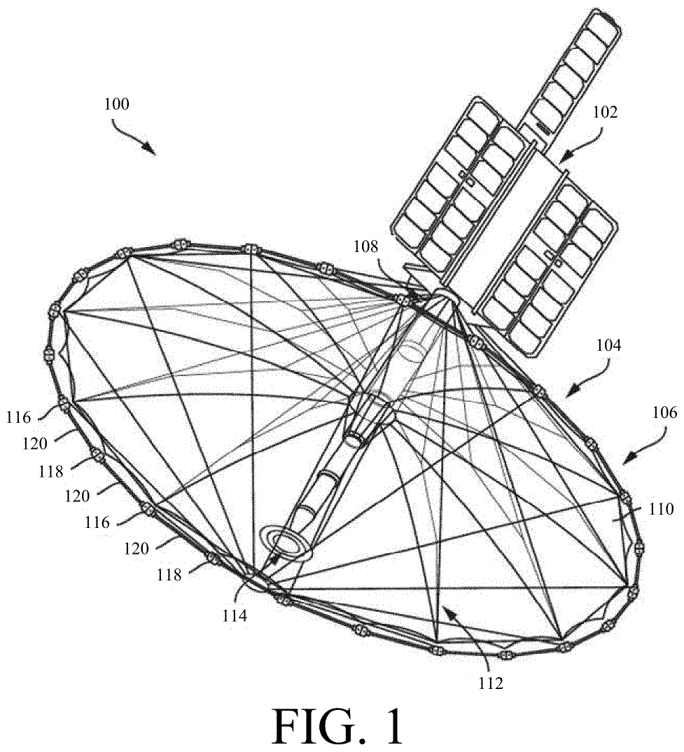

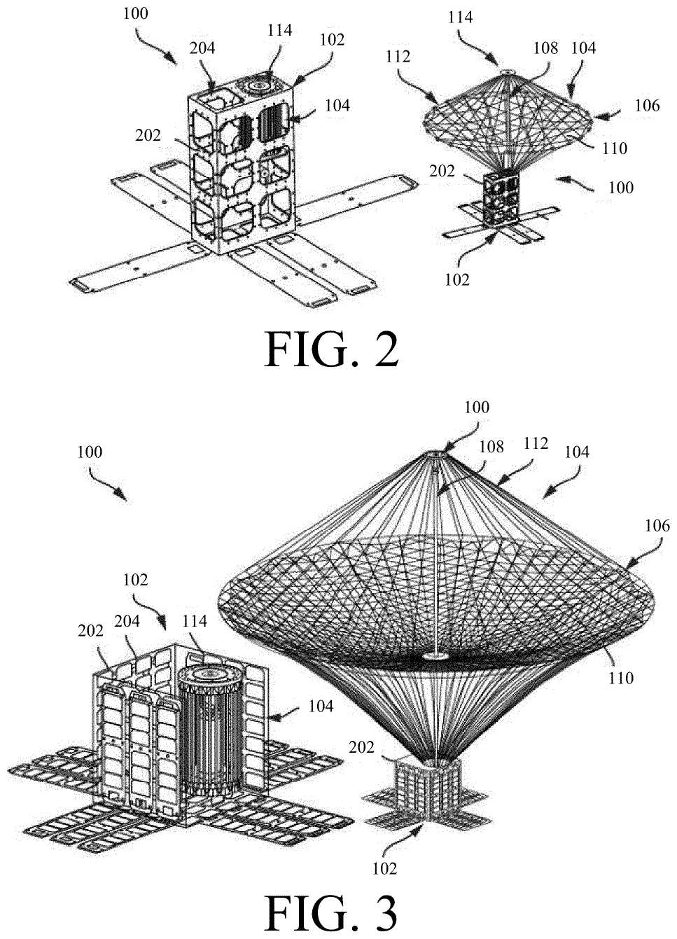

Referring to FIGS. 1-4, an illustration of an illustrative deployable mesh reflector system 100 is provided. Notably, certain cords are not shown in FIG. 1 for each of illustration and description. The deployable mesh reflector system 100 generally comprises a housing or container 102 which is configured to stow a deployable mesh reflector 104. The housing 102 comprises a frame structure 202 which defines an interior space 204 for stowing of the deployable mesh reflector 104. The frame structure 202 may have various configurations and sizes depending on the size of the deployable mesh reflector 104. By way of example, the system 100 of FIG. 2 may include a deployable mesh reflector with a one (1) meter aperture that is stowed within the housing of a 2U cubesat packaging and with an approximately 10 cm×10 cm×20 cm volume, while the system 100 of FIG. 3 may include a deployable mesh reflector with a three (3) meter aperture that is stowed within the housing 102 of a 12U cubesat packaging and with an approximately 20 cm×20 cm×30 cm volume. In some scenarios, the housing 102 is in the nanosat or microsat range. As will be described in more detail hereinafter, the configuration of the hoop assembly 106 and the mast assembly 108 allow for a larger aperture reflector within a smaller volume than prior rib structures.

The deployable mesh reflector 104 generally comprises a collapsible, parabolic mesh reflector surface 110 which is supported by a circumferential hoop assembly 106. The hoop assembly 106 is supported by a mast assembly 108 via a plurality of cords 112. As illustrated in FIGS. 2 and 3, the hoop assembly 106 and the mast assembly 108 are configured to collapse into a stowed configuration which fits within the interior space 204 of the housing 102. An antenna feed assembly 114 is provided at the free end of the mast assembly 108. A top plate (not shown) closes off the housing 102 when in the stowed configuration. As described in more detail hereinafter, in addition to providing the feed function, the antenna feed assembly 114 also functions as part of the support system. A drive train assembly 400 (positioned within the housing 102) is configured to extend the mast assembly 108 to deploy the reflector surface 110. As will be described in more detail hereinafter, in some scenarios, the hoop assembly 106 is configured to be self-deploying such that the deployed hoop structure is achieved without the need for additional motors or the like.

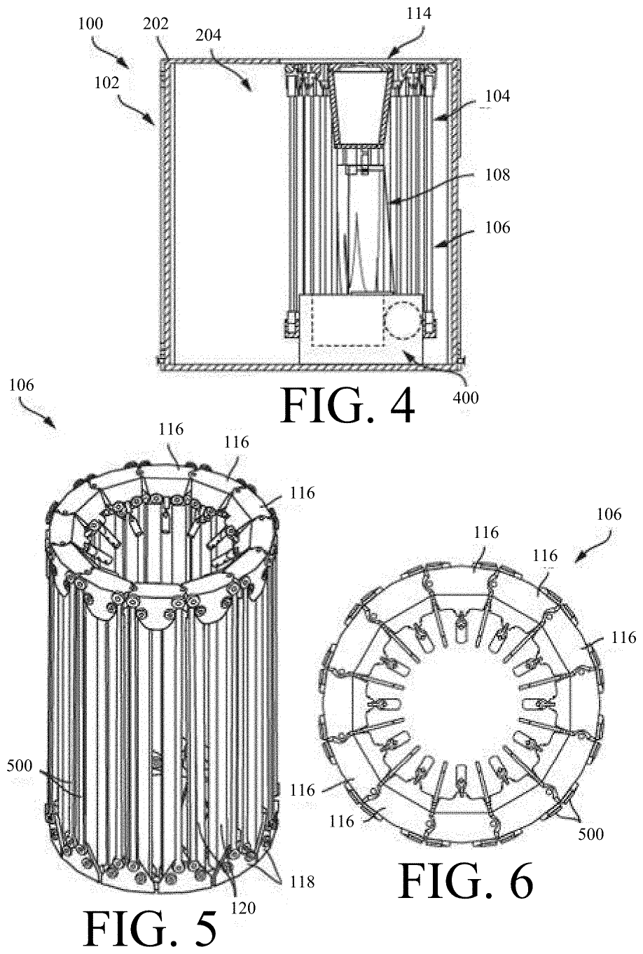

Referring now to FIGS. 5-12, an illustration of an illustrative hoop assembly 106 is provided. The hoop assembly 106 generally comprises a plurality of upper hinge members 116 which are interconnected with a plurality of lower hinge members 118 via link members 120. The upper and lower hinge members are circumferentially offset from one another such that a pair of adjacent link members 120 which are connected to one upper hinge member 116 are connected to two adjacent, but distinct lower hinge members 118. In this manner, upon deployment, the hoop assembly 106 defines a continuous circumferential hoop structure with link members extending between alternating upper and lower hinge members (see FIG. 1). In the stowed configuration illustrated in FIGS. 5 and 6, the upper hinge members 116 collapse adjacent to one another and the lower hinge members 118 collapse adjacent to one another with the link members 120 extending therebetween in generally parallel alignment.

In the illustrated embodiment, the hoop assembly 106 includes twelve upper hinge members 116 and twelve lower hinge members 118 and twenty-four link members 120. The present solution is not limited to such and the number of such components may be adjusted based on the desired stowed volume of the hoop assembly and the desired aperture of the reflector.

The aperture size can be increased by increasing the length or number of the link members 120, each of which has a resultant exponential increase in the aperture area. The structure allows for a maximum deployable aperture size while stowing the antenna in a minimum volume.

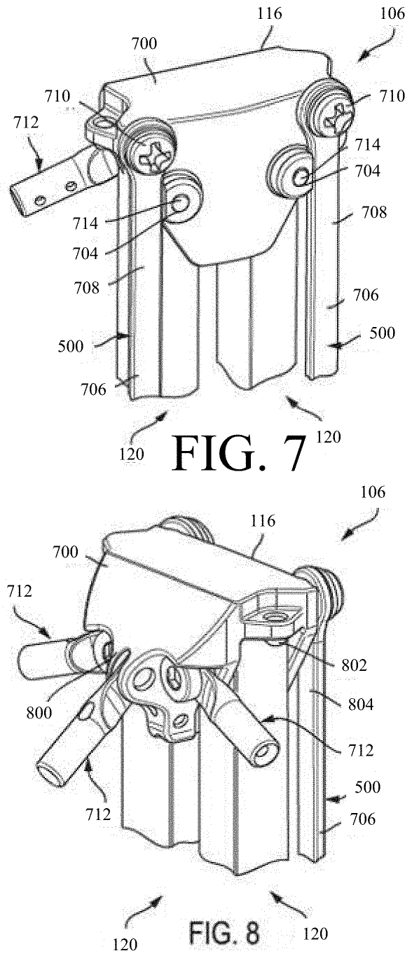

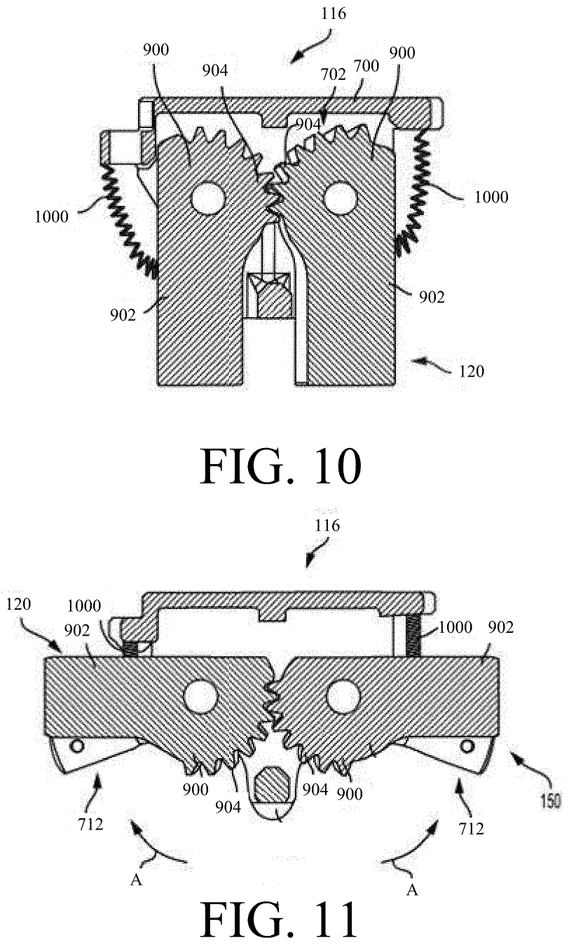

Referring now to FIGS. 7-12, there are provided illustrations that are useful for understanding the interconnection of the hinge members 116, 118 and the link members 120, as well as the operation thereof. While FIGS. 7-11 are described with respect to an upper hinge member 116, it is understood that the lower hinge members 118 have the same construction and operate in a similar manner. Each hinge member 116 includes a body 700 defining an interior chamber 702 (see FIG. 10) configured to receive the heads 900 of two link members 120 and to allow rotation of the link members 120 from the stowed configuration illustrated in FIG. 10 to the deployed configuration illustrated in FIG. 11. Each hinge member body 700 also supports a plurality of cord connectors 712 and sync rods 500, as will be described in more detail hereinafter.

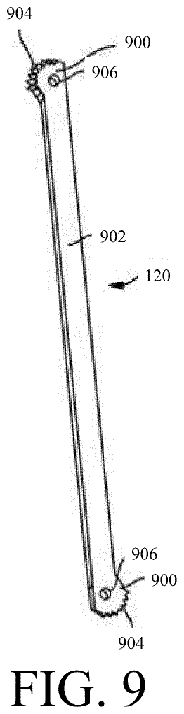

Referring now to FIG. 9, each link member 120 includes a linear rod 902 extending between opposed heads 900. The rods 902 are preferably manufactured from light weight, high strength materials, for example, carbon fiber. The heads 900 include gear teeth 904 and are preferably manufactured from a harder material, for example, Titanium. The invention is not limited to the identified materials and other materials may be utilized. The heads 900 are positioned such that on opposite ends of the link member 120, the gear teeth 904 face in opposite directions, thereby allowing one end to engage within an upper hinge 116 and the other end to engage with an offset lower hinge 118. Each head 900 includes a cross through bore 906 extending there through which is configured to receive a screw 714 or the like to pivotally connect the head 900 to the hinge body 700 at a pivot point 704.

Referring now to FIG. 10, there is provided an illustration that is useful for understanding an arrangement and operation of an extended spring 1000. Extended spring 1000 extends between the rod 902 and the hinge body 700. The extended spring 1000 urges the respective link member 120 to the deployed configuration as illustrated in FIG. 11. A hoop damping system may be provided internal to the link members 120 to assist with a controlled deployment.

Each hinge member 116, 118 includes a plurality of cord connectors 712 pivotally connected to the body 700, for example, at pivot point 800 (see FIG. 8). Each cord connector 712 is configured for attachment to a cord 112 which in turn may either connect to a top portion of the mast assembly 108, a bottom portion of the mast assembly 108 or to the reflector surface 110 to deploy and shape the reflector surface 110, as described hereinafter. In some scenarios, each of the hinge members 116, 118 is connected to both the top and bottom portions of the mast assembly 108 and to the reflector surface 110, although it is possible that only a subset of the hinge members 116, 118 are connected to the top portion of the mast assembly 108 and the remaining subset of the hinge members 116, 118 are connected to the bottom portion of the mast assembly 108. In each configuration, the load path goes from one end of the mast assembly 108, to the hinges 116, 118 of the hoop assembly 106 and to the other end of the mast using the cords 112.

Referring to FIG. 11, as explained above, the springs 1000 are configured to urge the gear link members 120 toward the deployed positioned as indicated by arrows A. As such, upon release of the hoop assembly 106 from the housing 102 (for example, via extension of the mast assembly or via a slide assembly), the springs 1000 cause the hoop assembly 106 (and thereby the reflector 110) to automatically deploy. Engagement of the gear teeth 904 ensures that adjacent link members 110 rotate in unison with one another for a smooth deployment of the hoop structure. A stop 802 may be defined on the hinge body 700 to define a maximum rotation of the gear link members 120.

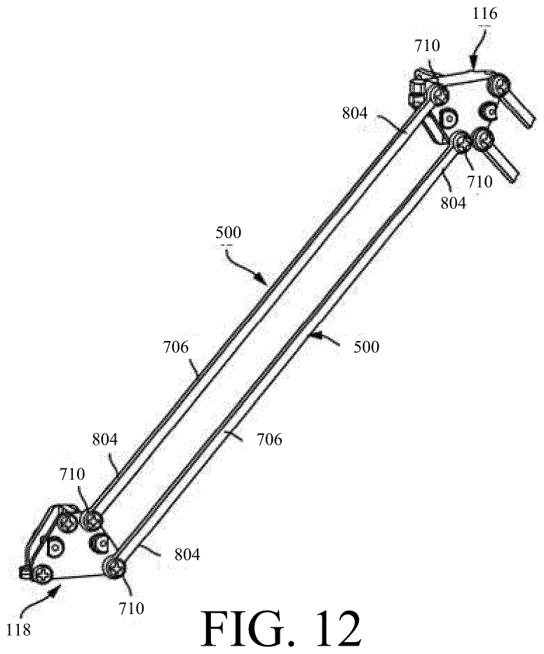

To further assist with a synchronous deployment of the hoop structure, sync rods 500 may be secured to the hinge members 116, 118 in an offset manner similar to the link members 120. Referring to FIG. 12, each sync rod 500 includes a rod 706 extending between opposed ends 708. Each end 708 is configured to be pivotally connected to a respective hinge body 700 at a pivot point 710. The sync rods 500 are preferably manufactured from light weight, high strength materials, for example, carbon fiber and the ends 804 may be manufactured from a harder material, for example, Titanium. A single sync rod 500 may extend between each connected upper and lower hinge member 116, 118 (see FIG. 7) or a pair of sync rods 500 may extend between each connected upper and lower hinge member 116, 118 (see FIG. 12). As the hinge members 116, 118 are moved apart and the link members 120 pivot, the sync rods 500 maintain the rotation angle between adjacent hinge members 116, 118 for synchronous deployment. Exemplary deployment sequences will be described hereinafter.

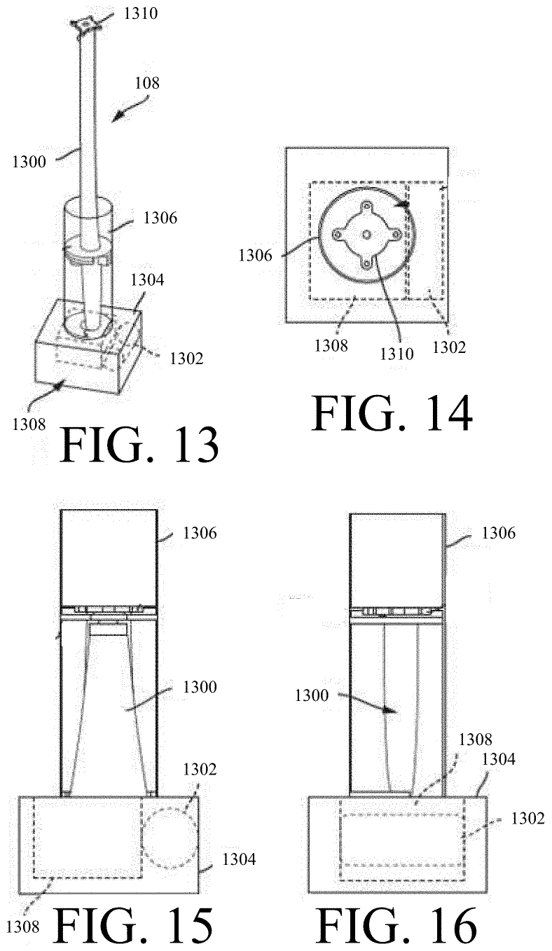

Referring to FIGS. 13-17, an illustration of an illustrative mast assembly 108 is provided. The mast assembly 108 includes an extendable boom 1300 with an antenna feed assembly 114 secured to a support plate 1310 at a free end thereof. With specific reference to FIGS. 13-16, the mast 108 is a split-tube type boom which is stored on a spool 1302 within a housing 1304 and extended through a shoot 1306. Slit-tube booms can have two configurations. A first configuration can include a stowed configuration (see FIGS. 15 and 16). A second configuration can include a deployed configuration (see FIG. 13). In the stowed configuration, the slit-tube boom can flatten laterally and be rolled longitudinally. In the deployed configuration, the slit-tube boom can be extended longitudinally and rolled or curved laterally. A drive train assembly 1308 within the housing 1304 is configured to extend the split tube boom 1300 for deployment. While a split type boom is described with respect to the present embodiment, the invention is not limited to such and the mast 1308 may have other configurations, for example, a rolled boom with a lenticular or open triangular cross section, or a pantograph configuration. As a further example, the mast assembly may include a plurality of links joined by hinges which is moveable between a collapsed configuration wherein the link members extend substantially parallel to one another and an expanded configuration wherein the link members align co-linear to one other. As another example, the extendible mast assembly may include a plurality of links that slide relative to one another such that the mast assembly automatically extends from a collapsed configuration where the links are nested together and an expanded configuration wherein the link members extend substantially end to end.

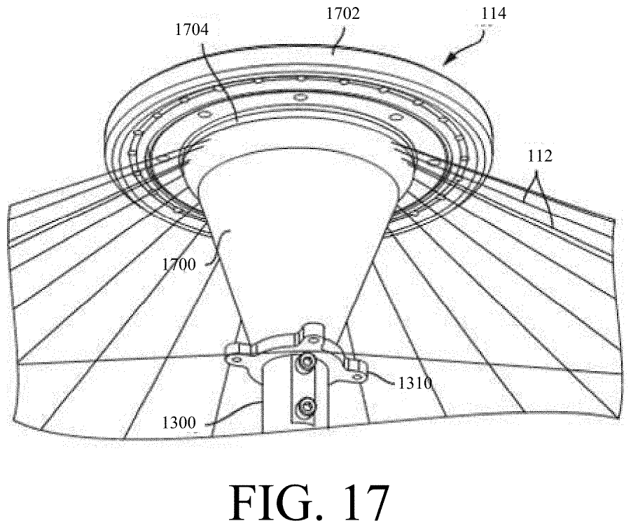

Referring to FIG. 17, there is provided an illustration of an illustrative antenna feed assembly 114. The antenna feed assembly 114 is connected to the support plate 1310 and defines a part of the mast assembly 108. A support structure 1700 extends between the support plate 1310 and the antenna feed assembly 114. The antenna feed assembly 114 includes an antenna feed plate 1702 which is configured to function as an antenna feed in a known manner. Additionally, an upper cord plate 1704 is secured to an underside of the antenna feed plate 1702, and is configured for connection of the cords 112 which extend from the cord connectors 702.

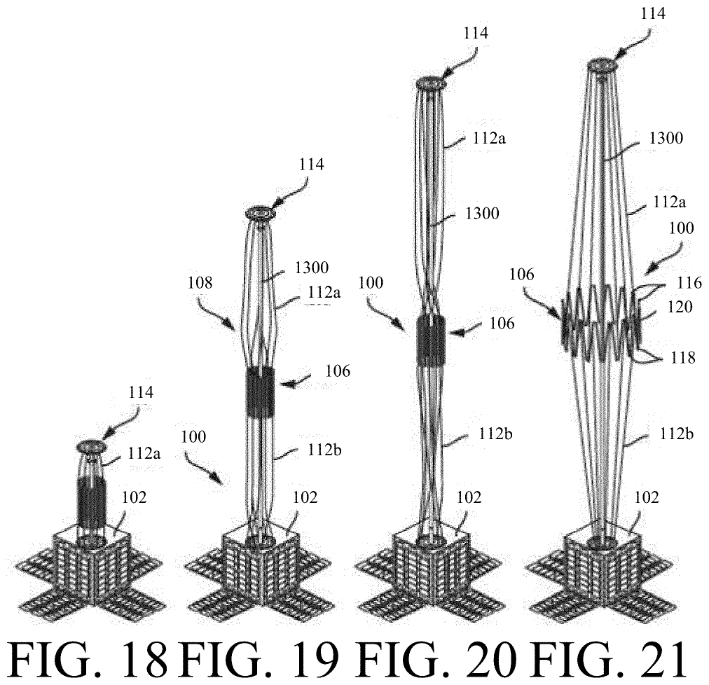

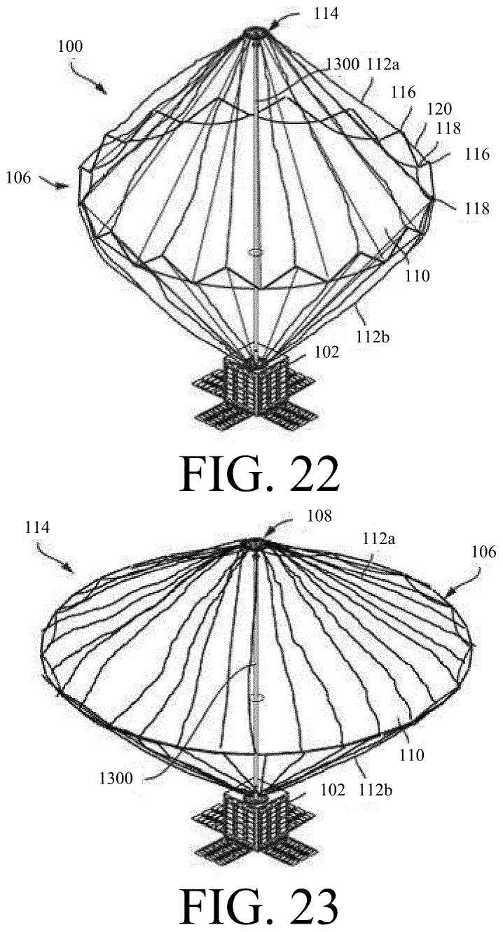

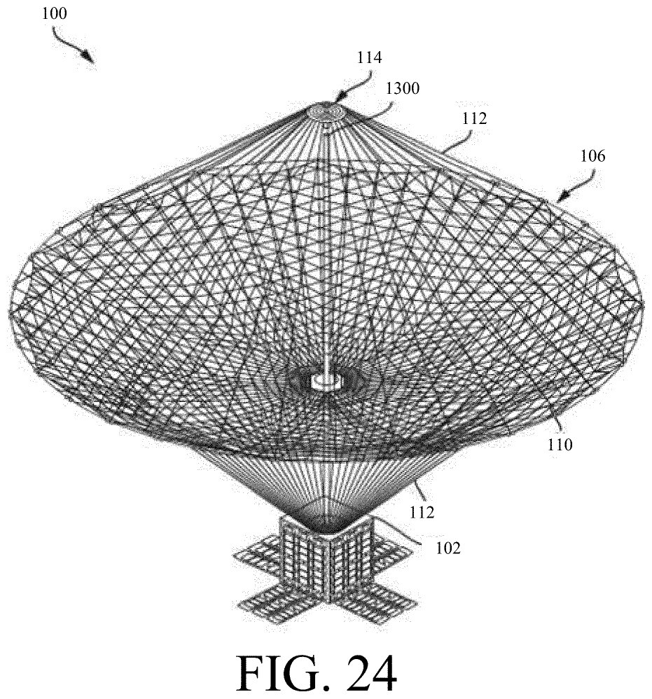

An illustrative deployment sequence for the deployable mesh reflector system 100 will now be described with reference to FIGS. 18-24. Referring to FIG. 18, the drive train assembly 1308 (not shown) is activated such that the mast 1300 is extended and the cords 112a are released from the housing 102. As the mast 1300 continues to extend as illustrated in FIG. 19, the hoop assembly 106 moves therewith, supported between the cords 112a, 112b. As the hoop assembly 106 is released from the housing 102, the cords 112b are released. The mast 1300 continues to extend beyond its normal deployed position, for example, to about 150% deployment, as illustrated in FIG. 20. As the cords 112a and 112b are tensioned, the hoop assembly 106 is released and the springs 1000 of the hinges 116, 118 begin to automatically deploy the hoop assembly 106 as illustrated in FIG. 21. The cords 112a and 112b connected between hoop 106 and the top or bottom portion of the mast 1300 stall the automatic deployment of the hoop 106 because of the extension beyond the normal deployed position. Thereafter, the mast 1300 is retracted as illustrated in FIG. 22 such that the hoop assembly 106 expands in a controlled manner and the reflector surface 110 is expanded therewith. As illustrated in FIG. 23, the mast 1300 may be retracted to less than the fully deployed length to allow the hoop assembly 106 to deploy over-center, however, such may not be required. Finally, as illustrated in FIG. 24, the mast 1300 is extended to the normal deployed position and the reflector system 100 is in an operational deployed configuration. Collapsing of the hoop assembly 106 for stowing may be done manually by pivoting the link members 120 to the stowed configuration as the mast assembly 108 is lowered.

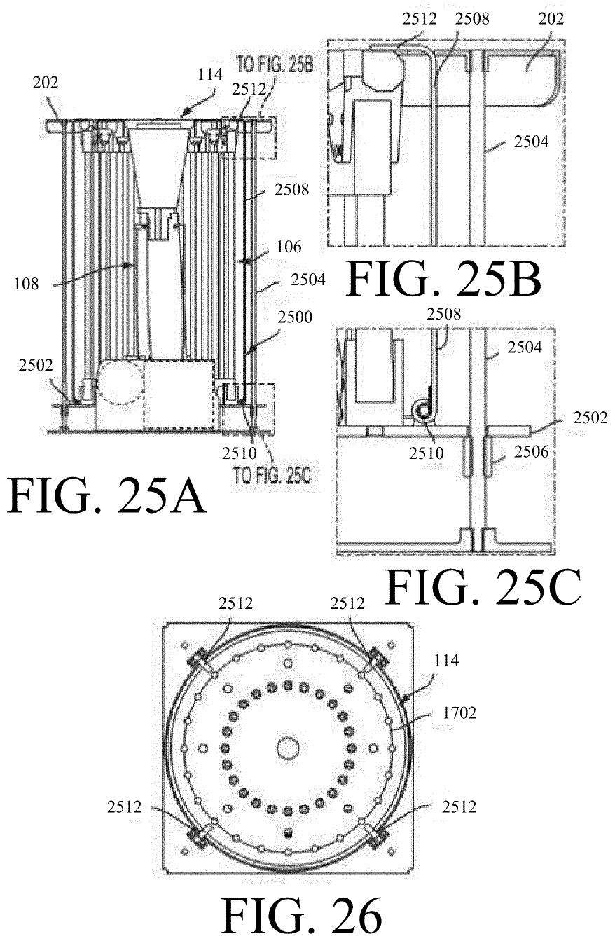

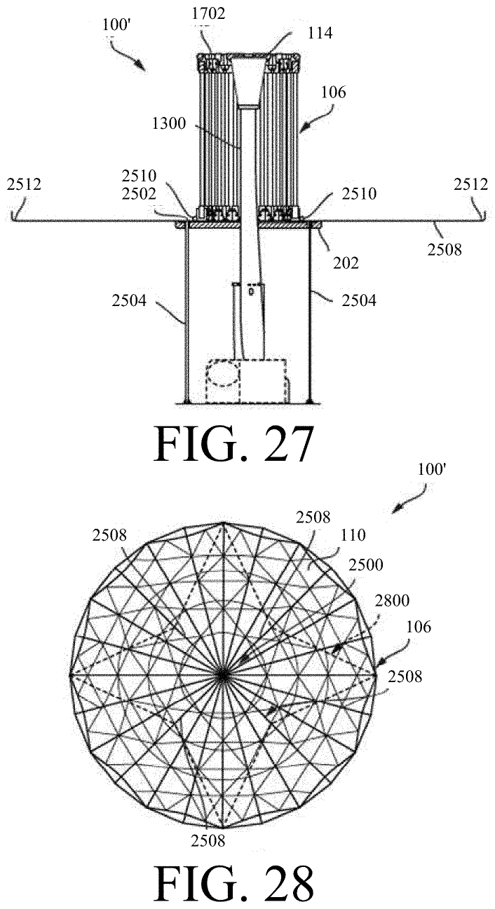

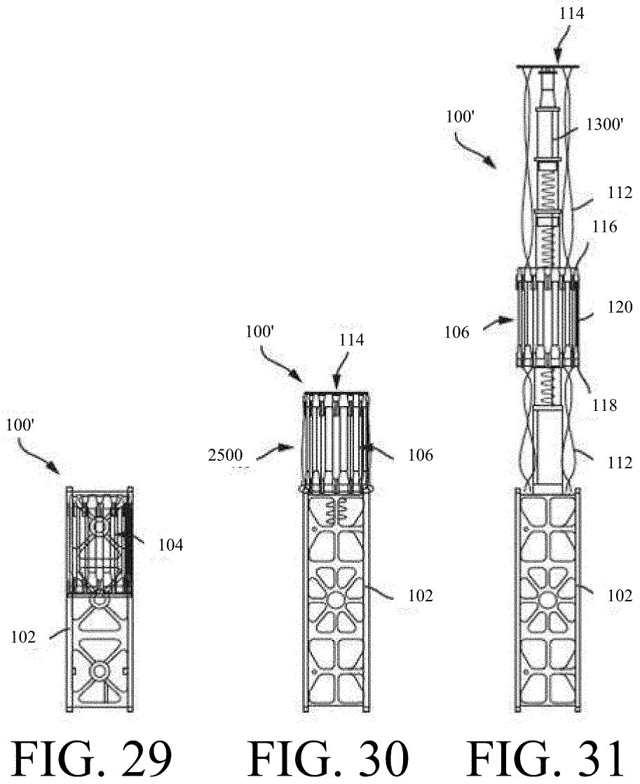

Referring to FIGS. 25A-28, a deployable mesh reflector system 100′ incorporating a push-out mechanism 2500 will be described. The push-out mechanism 2500 is configured such that the hoop assembly 106 remains engaged with the antenna feed assembly 114 during initial deployment of the mast 1300. The push-out mechanism 2500 includes a plate 2502 upon which the hoop assembly 106 is supported. The plate 2502 is guided for movement relative to the housing frame 202 via a plurality of rails 2504. Guide bushings 2506 or the like extend from the plate 2502 and move along the rails 2504. To prevent the antenna feed assembly 114 from moving away from the hoop assembly 106, a plurality restraint members 2508 extend from a biased, pivot connection 2510 at the plate 2502 to a latch member 2512 which extends about the antenna feed plate 1702. Referring to FIG. 29, when the mast 1300 is deployed, the restraint members 2508 ensure that the hoop assembly 106 and antenna feed assembly 114 move together until the hoop assembly 106 is beyond the housing frame 202, at which point the plate 2502 stops moving and the restraint members 2508 are forced to disengage the antenna feed plate 1702 as the mast 1300 continues to extend. While a latch push-out mechanism is illustrated, other mechanisms, for example, magnets, ball detents and the like, may be utilized to prevent deployment until the hoop assembly 106 is beyond the housing frame 202.

Referring to FIG. 28, the reflector system 100′ is illustrated with a torsion cord 2800 which provides additional torsional stiffness to the reflector 110. The torsion cord 2800 extends between the hoop assembly 106 and a portion of the housing (not shown) or, as in the illustrated embodiment, a portion of the slide mechanism 2500. In the illustrated embodiment, upon deployment, the torsion cord 2800 extends from the hoop assembly 106 to the restraint members 2508 which serve as torsion arms. The torsion cord 2800 may additionally or alternatively engage the housing frame 202 or the like.

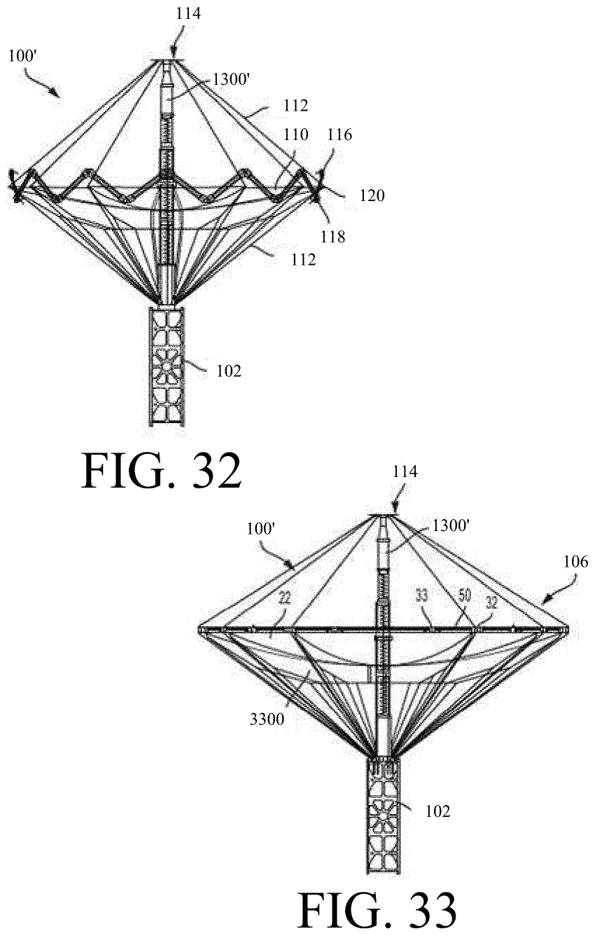

Referring to FIGS. 29-33, an alternative deployment sequence will be described. With reference to FIG. 29, the deployable mesh reflector 104 is in the stowed configuration within the housing 102. In FIG. 30, the hoop assembly 106 and antenna feed assembly 114 have been extended together via the slide mechanism 2500. As the mast 1300′ continues to extend as illustrated in FIG. 31, the hoop assembly 106 moves therewith, supported between the cords 112, and the springs of the hinges 116, 118 begin to cause the link members 120 to pivot and deploy. In FIG. 32, the mast 1300′ may be extended beyond the normal deployed position such that cord tension on the upper and lower hinge members 116, 118 helps to avoid overly rapid deployment similar to the previous embodiment. Thereafter, the mast 1300′ is retracted as illustrated in FIG. 33 such that the hoop assembly 106 expands in a controlled manner and the reflector surface 110 is expanded therewith until the reflector system 100′ is in an operational deployed configuration. It is noted in FIG. 33, that the reflector surface may include additional features, for example, a radial fin support film 3300, extending generally perpendicular to the reflector surface 110, to provide additional support.

The deployable mesh reflector systems 100, 100′ described herein produce the maximum deployable aperture size, while stowing the antenna in a minimum volume.

The above described deployable mesh reflector systems 100, 100′ can be further improved. In this regard, it should be understood that each reflector system 100, 100′ has a low frequency torsional mode that results in a deformation of the reflective mesh surface. This deformation of the reflective mesh surface impacts the overall performance of the reflector systems. The present solution adds a structural means to improve the low frequency torsional mode of the reflector systems. The structural means is configured to increase the stiffness and the damping of the mesh reflector so as to eliminate the sustained torsional mode of the systems. The structural means will become evident as the discussion progresses.

There are conventional solutions for addressing the low frequency torsional mode of reflector systems. One such conventional solution comprises a perimeter truss structure. This conventional solution offers an offset reflector configuration. The present solution differs from this conventional solution in that it provides superior compaction ratios and facilitates center fed antenna configurations for unique capabilities.

As discussed above, the deployable mesh reflector systems 100, 100′ each comprise a series of cords, a center mast and a circumferential hoop. The hoop is supported by the series of cords that run from a base of the mast out to the hoop and then up to the top of the mast to form an overall structure. All of these cords are radial in nature, i.e., the cords stay in plane when radial slices of the reflector system are taken. This results in very little structural reinforcement for torsional mode. So for instance, if the hoop is rotated or otherwise twisted, then a reactive force is near zero for small displacements and increases as the hoop is rotated/twisted further. This results in low amplitude oscillations of the system which cause distortions of the reflector surface.

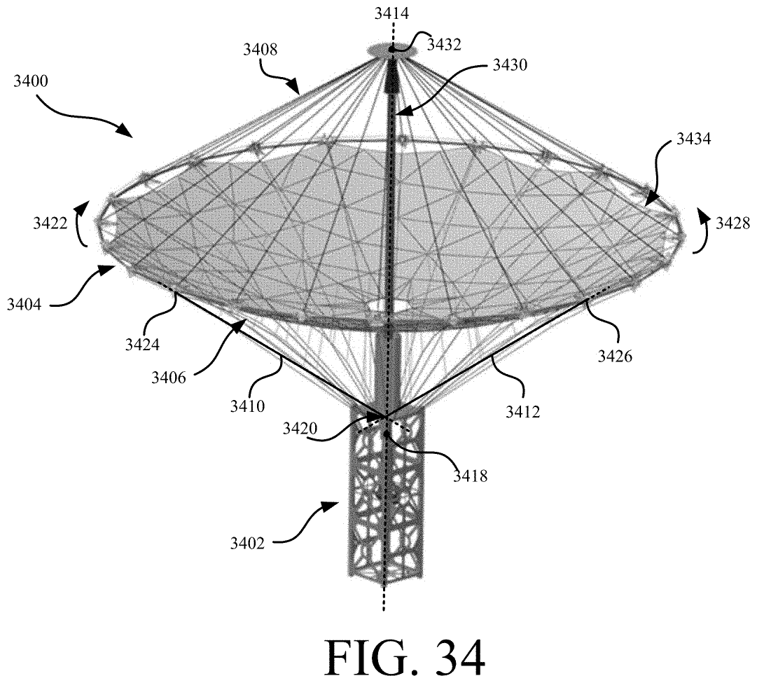

Referring now to FIG. 34, there is provided an illustration of an illustrative deployable mesh reflector system 3400. The deployable mesh reflector system 3400 is similar to deployable mesh reflector systems 100, 100′, but has certain additional structural elements to prevent distortion of the reflector surface during the torsional mode.

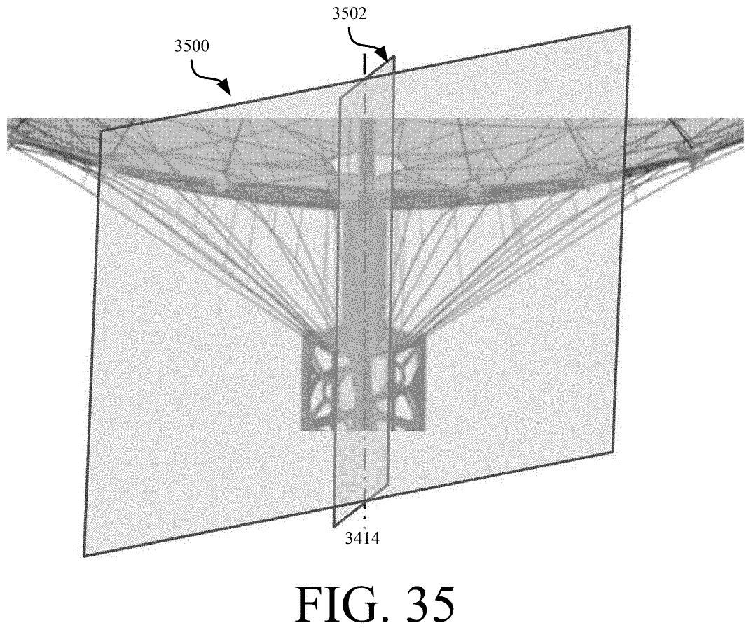

In this regard, it should be understood that the deployable mesh reflector system 3400 comprises a series of cords 3406, 3408, a center mast 3430, and a circumferential hoop 3404. The circumferential hoop 3404 is supported by the cords 3406, 3408. The hoop 3404 and cords 3406, 3408 structurally support and facilitate shaping of the reflective surface 3434. Cords 3406 extend from a chassis 3402 to the hoop 3404, and cords 3408 extend from the hoop 3404 to the top of the mast 3430. Notably, the bottom cords 3406 all extend in directions so that they are pointed at the same virtual point 3418 on the mast 3430 and/or axis of symmetry 3414. Similarly, the top cords 3408 all extend in directions so that they point at the same virtual point 3432 on the mast 3430 and/or axis of symmetry 3414. These cords 3406, 3408 are radial in nature as shown in FIG. 35, i.e., the cords 3406, 3408 each entirely reside in a single given plane 3500, 3502 defined by a radial slice of the reflector system 3400 that intersects the axis of symmetry 3414. The planes 3500, 3502 in which the cords 3406, 3408 reside both intersect the axis of symmetry 3414.

The additional structural elements each comprise at least one set of cords 3410, 3412. A first cord 3410 of the set is provided to oppose positive twisting of the hoop 3404 in a first direction 3422 with tension, and a second cord 3412 of the set is provided to oppose negative twist of the hoop 3404 in a second opposed direction 3428 with tension. Although these cords 3410, 3412 are not required for overall structural support and/or reflector surface shaping, they are provided to drive non-linearity into the torsional response of the system effectively limiting the ringing of the torsional mode and resultant cyclical performance impacts. No other existing reflector system architecture has limited the torsional response of the reflector system in this way or to this effect. As such, the present solution provides an improved deployable mesh reflector system.

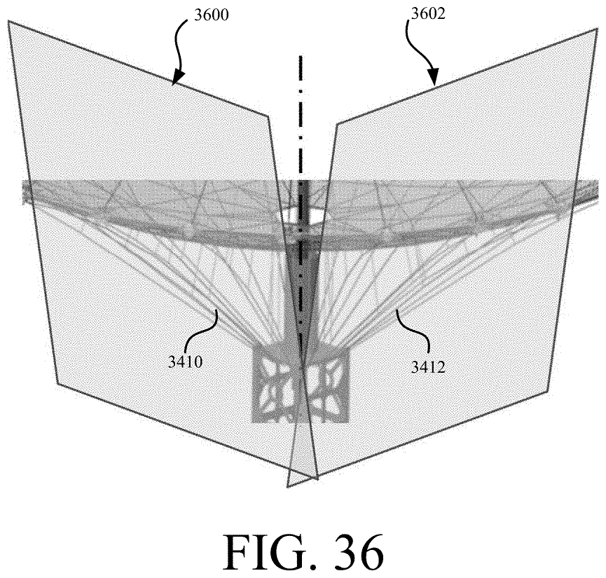

The cords 3410, 3412 extend off axis, i.e., the cords 3410, 3412 are not in plane with the existing cord network 3406, 3408 meaning that (i) each cord does not lie in any plane defined by radial slices of the reflector system 3400 that intersects the axis of symmetry 3414 and (ii) each cord resides in a plane 3600, 3602 that does not intersect the axis of symmetry 3414 as shown in FIG. 36.

The cords 3410, 3412 can intersect with each other at a lower location to provide triangular stiffening. The cords could be mounted at any location on the chassis 3402 and/or spacecraft (not shown) to increase angular separation and/or reduce cord load. For example, additional cord 3410 extends from a point 3420 of the chassis 3402 to a tangential point 3424 on the circumferential hoop 3404, and additional cord 3412 extends from a point 3420 of the chassis 3402 to a tangential point 3426 of the circumferential hoop 3404. Point 3420 is horizontally offset from the axis of symmetry 3414. This results in a structural member that can prevent rotation of the circumferential hoop 3404 in directions 3422, 3428. As such, the structural member provides a reflector system that resists torsional displacement of the circumferential hoop 3404 from its initial tangential position.

The additional cords 3410, 3412 can be formed to the same or different material used to form the series of cords 3406, 3408. The material can include, but is not limited to, a graphite material and/or a glass material. In some scenarios, the additional cords 3410, 3412 are formed of a material that is stiffer than the material used to form the series of surface shaping cords 3406, 3408. The present solution is not limited in this regard.

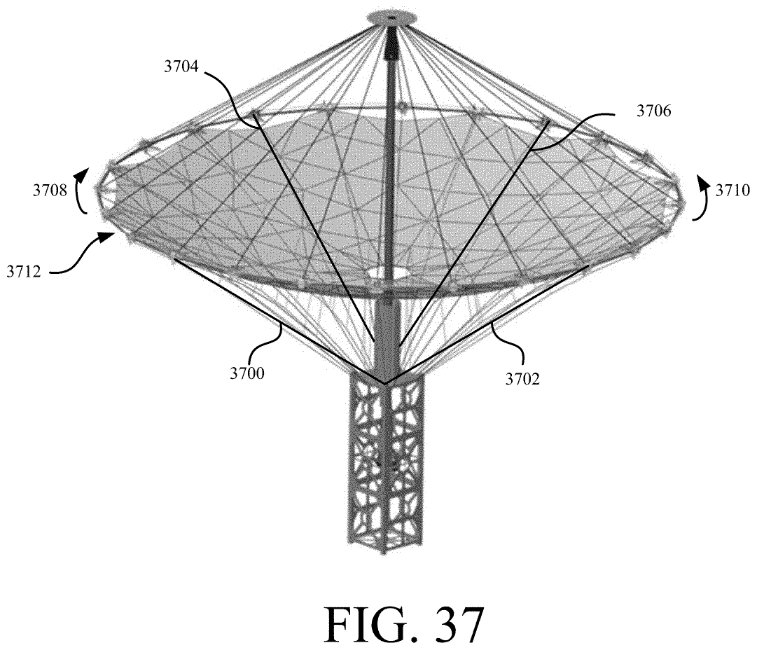

The present solution is not limited to the architecture shown in FIG. 34. In this regard, it should be understood that the deployable mesh reflector system can have N sets of additional cords, where N is any integer equal to or greater than one. For example, as shown in FIG. 37, the deployable mesh reflector system comprises a first set of additional cords 3700, 3702 and a second set of additional cords 3704, 3706. A first cord 3700 of the first set is provided to oppose positive twisting of the circumferential hoop 3712 in a first direction 3708 with tension, and a second cord 3702 of the first set is provided to oppose negative twist of the circumferential hoop 3712 in a second opposed direction 3710 with tension. Similarly, a first cord 3706 of the second set is provided to oppose positive twisting of the circumferential hoop 3712 in a first direction 3708 with tension, and a second cord 3704 of the second set is provided to oppose negative twist of the circumferential hoop 3712 in a second opposed direction 3710 with tension. Notably, the multiple sets of additional cords can be coupled to the chassis at the same location (not shown) or at different locations (shown in FIG. 37).

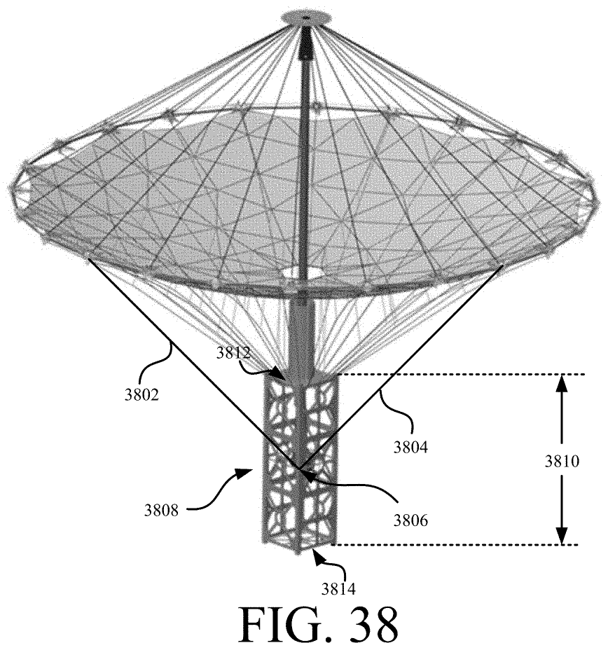

It should also be noted that the additional cords can be coupled at any location on the chassis or other base structure (e.g., a spacecraft). For example, as shown in FIG. 34, the additional cords 3410, 3412 are coupled to a top of the chassis 3402. In contrast, as shown in FIG. 38, the additional cords 3802, 3804 are coupled to an intermediate location 3806 on the chassis 3808. The intermediate location can include, but is not limited to, any location along the length 3810 of the chassis 3808 that resides between a top end 3812 and a bottom end 3814 thereof, and/or that is horizontally offset from the mast's center axis (or axis of symmetry).

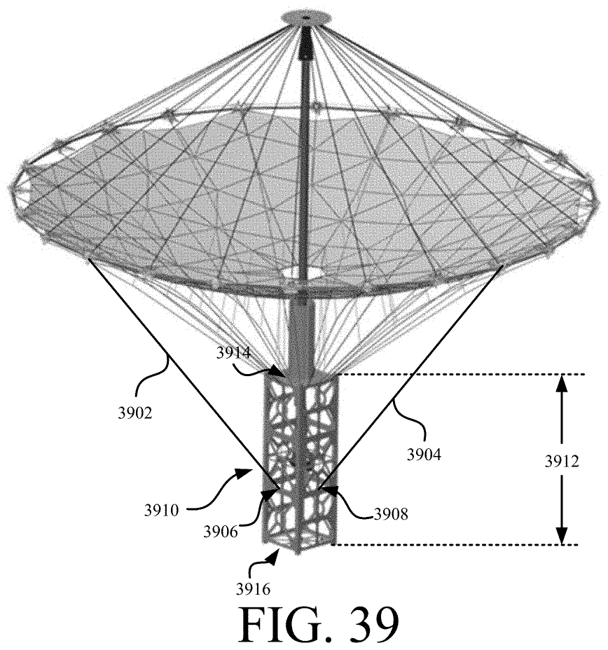

In some scenarios, the additional cords are not coupled at the same location on the chassis or other base structure (e.g., a spacecraft). For example, as shown in FIG. 39, the additional cords 3902, 3904 are respectively coupled to different intermediate locations 3906, 3908 on the chassis 3910. The intermediate locations can include, but are not limited to, any locations along the length 3912 of the chassis 3910 that reside between a top end 3914 and a bottom end 3916, and/or that are horizontally offset from the mast's center axis (or axis of symmetry).

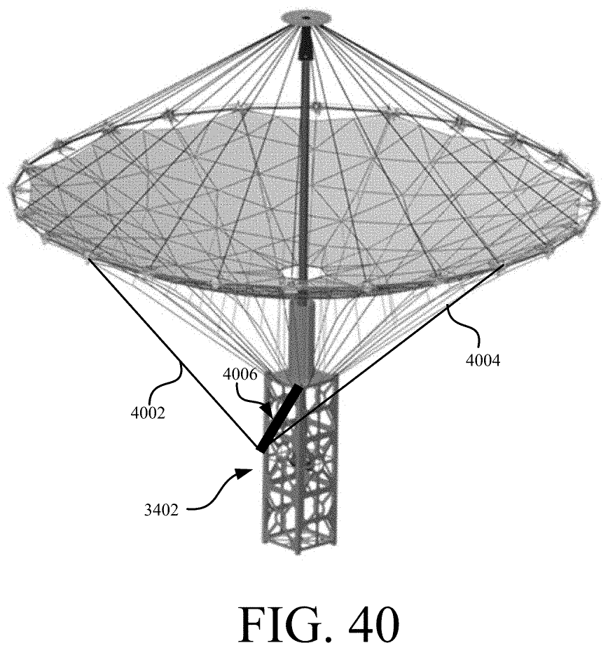

In other scenarios, the additional cords are coupled to the chassis or other base structure (e.g., a spacecraft) via one or more deployable or extendable parts thereof. For example, as shown in FIG. 40, the additional cords 4002, 4004 are coupled to an extendable part 4006. The extendable part 4006 can include, but is not limited to, a telescoping boom, an articulating arm, a hinged structure, and/or a rotatable structure.

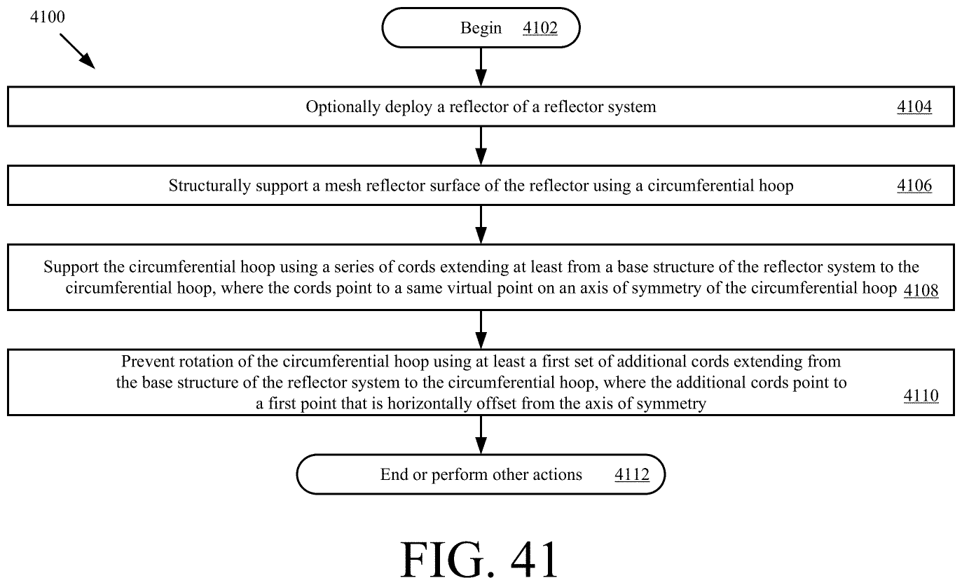

Referring now to FIG. 41, there is provided a flow diagram of an illustrative method 4100 for operating a reflector system (e.g., reflector system 3400 of FIG. 34). Method 4100 includes a plurality of operations 4104-4110. The order in which these operations 4104-4410 can be the same as that shown in FIG. 41 or different than that shown in accordance with a given application.

Method 4100 begins with 4102 and continues with 4104 where a reflector of a reflector system is optionally deployed. Notably, 4104 can involve actuation of the boom so as to cause the tightening of cords whereby the reflector is deployed. Next in 4106, a mesh reflector surface (e.g., mesh reflector surface 3434 of FIG. 34) is structurally supported using a circumferential hoop (e.g., circumferential hoop 3404 of FIG. 34). The circumferential hoop is supported in 4108 using a series of cords (e.g., cords 3406 of FIG. 34) extending at least from a base structure (e.g., chassis 3402 of FIG. 34) of the reflector system to the circumferential hoop and from the end of the boom to the circumferential hoop (e.g., cords 3408 of FIG. 34). The cords all point to a virtual point (e.g., virtual point 3418 of FIG. 34) on an axis of symmetry (e.g., axis 3414 of FIG. 34) of at least the circumferential hoop both above the hoop and below the hoop. In 4110, rotation of the circumferential hoop is prevented using at least a first set of additional cords (e.g., cords 3410, 3412) extending from the base structure of the reflector system to the circumferential hoop. The first set of additional cords comprises a first cord that opposes positive twisting of the circumferential hoop in a first direction with tension, and a second cord that opposes negative twisting of the circumferential hoop in a second opposed direction with tension. The first and second additional cords both point to a first point (e.g., point 3420 of FIG. 34) that is horizontally offset from the axis of symmetry. Subsequently, 4112 is performed where method 4100 ends or other actions are performed.

In some scenarios, the cords of the series of cords each entirely reside in a single given plane (e.g., plane 3500 or 3502 of FIG. 35) defined by a radial slice of the reflector system that intersects the axis of symmetry. The additional cords of the first set reside in multiple planes inclined to the axis of symmetry. The additional cords of the first set may each also reside in a plane that does not intersect the axis of symmetry.

In those or other scenarios, rotation of the circumferential hoop is further prevented using a second set of additional cords extending from the base structure of the reflector system to the circumferential hoop. The additional cords of the second set both point to a second point that is horizontally offset from the axis of symmetry and/or that is different than the first point to which the additional cords of the first set point. Additionally or alternatively, the additional cords of the first set and/or second set are coupled to one or more extendable parts of the base structure.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as defined in the claims.

1. A method for operating a reflector system, comprising:
structurally supporting a mesh reflector surface using a circumferential hoop coupled to a boom via a plurality of cords;
supporting the circumferential hoop using a series of cords extending at least from a base structure of the reflector system to the circumferential hoop and from the boom to the circumferential hoop, where a line of action of all the cords intersect an axis of symmetry of the circumferential hoop; and
preventing rotation of the circumferential hoop using at least a first set of additional cords extending from the base structure of the reflector system to the circumferential hoop, where the additional cords of the first set both point to a first point that is horizontally offset from the axis of symmetry.

2. The method according to claim 1, wherein the additional cords of the first set reside in multiple planes that intersect the axis of symmetry at only a point.

3. The method according to claim 1, wherein the additional cords of the first set each resides in a plane that does not intersect the axis of symmetry.

4. The method according to claim 1, wherein the first set of additional cords comprises a first cord that opposes positive twisting of the circumferential hoop in a first direction with tension, and a second cord that opposes negative twisting of the circumferential hoop in a second opposed direction with tension.

5. The method according to claim 1, wherein rotation of the circumferential hoop is further prevented using a second set of additional cords extending from the base structure of the reflector system to the circumferential hoop, where the additional cords of the second set both point to a second point that is horizontally offset from the axis of symmetry and that is different than the first point to which the additional cords of the first set point.

6. The method according to claim 1, wherein the additional cords of the first set are coupled to one or more extendable parts of the base structure.

7. A reflector system, comprising:
a boom;
a circumferential hoop coupled to the boom via a plurality of cords and having an axis of symmetry;
a mesh reflector surface structurally supported by the circumferential hoop;
a series of cords structurally supporting the circumferential hoop from the boom, said cords coupled to the circumferential hoop and each oriented such that a line of action intersects the axis of symmetry;
at least a first set of additional cords preventing rotation of the circumferential hoop, the additional cords coupled to the circumferential hoop and pointing to a first point that is horizontally offset from the axis of symmetry.

8. The reflector system according to claim 7, wherein the additional cords of the first set reside in multiple planes that intersect the axis of symmetry at only a point.

9. The reflector system according to claim 7, wherein the additional cords of the first set each resides in a plane that does not intersect the axis of symmetry.

10. The reflector system according to claim 7, wherein the first set of additional cords comprises a first cord that opposes positive twisting of the circumferential hoop in a first direction with tension, and a second cord that opposes negative twisting of the circumferential hoop in a second opposed direction with tension.

11. The reflector system according to claim 7, wherein rotation of the circumferential hoop is further prevented using a second set of additional cords extending from the boom a base structure of the reflector system to the circumferential hoop, where the additional cords of the second set both point to a second point that is horizontally offset from the axis of symmetry.

12. The reflector system according to claim 11, wherein the second point is different than the first point to which the additional cords of the first set point.

13. The reflector system according to claim 11, wherein each of the first and second sets of additional cords comprises a first cord that opposes positive twisting of the circumferential hoop in a first direction with tension, and a second cord that opposes negative twisting of the circumferential hoop in a second opposed direction with tension.

14. The reflector system according to claim 7, wherein the additional cords of the first set are coupled to a base structure of the reflector system at a first end to which the series of cords are also attached.

15. The reflector system according to claim 7, wherein the additional cords of the first set are coupled to a base structure of the reflector system at an intermediate location along a length of the base structure that resides between a first end and second end of the base structure, and that is horizontally offset from the axis of symmetry.

16. The reflector system according to claim 7, wherein the additional cords of the first set are coupled to a base structure of the reflector system at a first end which is opposed to a second end of the base structure to which the series of cords are coupled.

17. The reflector system according to claim 7, wherein the additional cords of the first set are coupled to one or more extendable parts of a base structure.

18. The reflector system according to claim 7, wherein the additional cords are formed of a different material than the material used to for the series of cords.
